(19) United States
(12) Patent Application Publication
(10) Pub. No.: US 2003/0175520 A1
(43) Pub. Date: Sep. 18, 2003

(54) Formed composite structural members and methods and apparatus for making the same

(76) Inventors: James T. Grutta, Salt Lake City, UT (US); Larry E. Stanley, Bountiful, UT (US)

Correspondence Address: Edmund P. Anderson, Esq., Delphi Technologies, Inc. M/C 480.414.420, 4th Floor, 1450 West Long Lake, Troy, MI, 48098, US

(21) Appl. No.: 10/098,790

(22) Filed: Mar. 13, 2002

(51) Int. Cl. B32B 9/04; B29C 43/20; B29C 43/52

(52) U.S. Cl. 428/411.1; 264/237; 264/322; 425/407

(57) ABSTRACT

Formed composite structural members and methods and apparatus for making the same are described. The composite members are formed by using a continuous roll pressing process or apparatus, or a consolidated cold press process. Using these processes, the composite members are formed with a better surface finish using shorter cycle times and without spreading of the tows.

### STATEMENT REGARDING FEDERALLY SPONSORED RESEARCH AND DEVELOPMENT

The U.S. Government may have certain rights in this invention pursuant to Contract No. 329515-AMB.

### FIELD OF THE INVENTION

The present invention relates to structural members and methods and apparatus for making the same. In particular, the present invention relates to formed composite structural members and methods and apparatus for making the same.

### BACKGROUND OF THE INVENTION

In recent years there has been an increasing emphasis on the use of lightweight composite materials. One application, for example, has been their use to improve the efficiency of motor vehicles. To that end, the United States Government and the U.S. Council for Automotive Research (USCAR)—which represents Daimler Chrysler, Ford, and General Motors have partnered to form the Partnership for a New Generation of Vehicles (PNGV). One goal of PNGV is to develop technology, such as composite technology, that can be used to create environmentally friendly vehicles with up to triple the fuel efficiency, while providing today's affordability, performance and safety. For example, PNGV wants to improve the fuel efficiency of today's vehicles from about 28 miles per gallon (mpg) to about 83 mpg and a 40-60% decrease in the present curb weight (3200 pounds).

Composites are a mixture or combination, on a macro scale, of two or more materials that are solid in the finished state, are mutually insoluble, and differ in chemical nature. There exist numerous known methods to make composite structural members. One of these methods is known in the art and referred to as thermoplastic transfer-press compression molding. See, for example, the product brochure issued by Applied Fiber Systems entitled TowFlex Molding (date unknown), the description of which is incorporated herein by reference. Generally, in this method for making composite members (as illustrated in FIG. 1), unconsolidated composite plies 2 are assembled into a perform 4. The preform is then loaded into a matched metal mold 6. The mold is then loaded into a preheated platen press 8 and a contact pressure is applied while the press is heated. When the desired temperature is obtained, a pressure of 100-500 psi is then applied for about 1-15 minutes. The hot mold is then transferred to a chilled cooling press 10 for cooling, during which a pressure of 100-500 psi is applied. After the mold is cooled, the pressure is released and the formed composite part 12 is removed from the mold.

Unfortunately, this thermoplastic stamping process has several disadvantages. First, long cycle times of about 3-15 minutes are needed. Second, there is a significant fiber print throughout the composite part, yielding an undesirable surface finish. Finally, there is a large amount of spreading of the fiber tows.

### SUMMARY OF THE INVENTION

The invention provides formed composite structural members and methods and apparatus for making the same. The composite members are formed by using a continuous roll pressing process or apparatus, or a consolidated cold press process. Using these processes, the composite members are formed with a better surface finish using shorter cycle times and without spreading of the tows.

### BRIEF DESCRIPTION OF THE DRAWINGS

FIGS. 1-4 are views of composite structural members and methods and apparatus of making the same according to the invention, in which:

FIG. 1 depicts a known process for making a composite structural member;

FIG. 2 illustrates stacked plies used in one aspect of making the composite structural member according to the invention;

FIG. 3 illustrates one aspect of a process for making the composite structural member according to the invention; and

FIG. 4 illustrates another aspect of a process for making the composite structural member according to the invention.

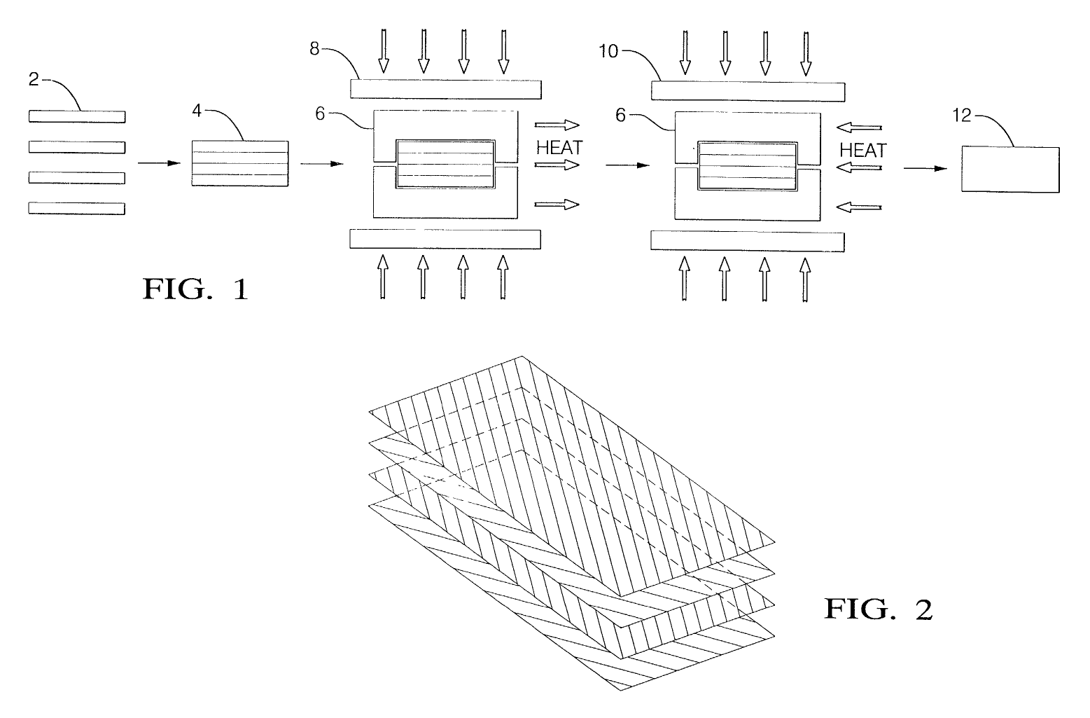

FIGS. 1-4 presented in conjunction with this description are views of only particular—rather than complete—portions of the composite structural members and methods and apparatus of making the same.

### DETAILED DESCRIPTION OF THE INVENTION

The following description provides specific details in order to provide a thorough understanding of the present invention. The skilled artisan, however, will understand that the present invention can be practiced without employing these specific details. Indeed, the present invention can be practiced by modifying the illustrated structural member and method and can be used in conjunction with apparatus and techniques conventionally used in the composite industry.

The composite structural members of the invention can have any shape or combination of shapes that can be formed by the process and apparatus described below. For example, the composite structural members can have a tubular or non-tubular shape, a complex shape, a contoured shape, a bent or straight shape, or a combination of shapes.

The structural members of the invention can be formed from any composite materials known in the art. In one aspect of the invention, the materials for the structural members comprise any suitable reinforced resin matrix material (RRMM), which is a resin matrix material (RMM) with continuous or discontinuous reinforcement material embedded in the resin matrix. In one aspect of the invention, the RMM is an organic resin matrix material (ORMM). See, for example, U.S. Pat. Nos. 5,725,920 and 5,309,620, the disclosures of which are incorporated herein by reference.

In one aspect of the invention, the ORMM can be a thermoplastic resin matrix material. Thermoplastic resins are polymeric materials that do not set irreversibly when heated, e.g., they soften when exposed to heat and then return to their original condition when cooled. Examples of thermoplastic resins include polypropylene, polyethelene, polyamides (nylons), polyesters (PET, PBT), polyether ketone (PEK), polyether ether ketone (PEEK), polyphenylene sulfide (PPS), polyphenylene oxide (PPO) and its alloys, and polyvinyl resins, or combinations thereof. The thermoplastic resins can contain various additives as known in the art, such as cross-linking agents, curing agents, fillers, binders, or ultraviolet inhibitors. Preferably, polyamides (nylons), polyester, PEEK, polycarbonate, and polypropylene resins are employed as the thermoplastic resin in the present invention.

The material used to reinforce the RMM of the present invention can be in any form that reinforces the resin matrix. Examples of reinforcement forms include unidirectional tape, multidirectional braids, woven fabrics, nonwoven fabrics, random mats (continuous and discontinuous strand), hand laid or stitched preforms, fibers, filaments, or whiskers, and combinations thereof. The type of material used to reinforce the RMM can be any type serving such a reinforcing function. Preferably, the form of the reinforcement materials for the resin matrix is a fiberous material, such as continuous or discontinuous fibers. Examples of fibers that can be employed in the invention include, S-Glass, E-Glass, aramid, graphite, carbon, ultra-high molecular weight polyethylene, boron, silicon carbide, ceramic, quartz, metals, isotropic metals (aluminum, magnesium and titanium), metal coated organic fibers, CAMP, hybrids of these fibers, or combinations of these fibers. See, for example, U.S. Pat. No. 6,117,534, the disclosure of which is incorporated herein by reference.

In yet another aspect of the invention, non- or partially-cured composite materials are used as the material for the structural members. Any composites known in the art such as laminar, particle, fiber, flake, and filled composites can be employed in the invention. The non- or partially-cured composite materials are an ORMM (thermoplastic resin) reinforced with a continuous fiber or thermoset materials.

Preferable composite materials used in the invention include thermoplastic composite materials (thermoplastic prepregs, or prepregs) typically in the form of sheets or laminates (or plies), which can be formed by impregnating a plurality of fiber reinforcement tows with a thermoplastic polymer. Methods of making thermoplastic prepreg sheets and the sheets themselves are well known. See, for example, those sheets described in U.S. Pat. No. 4,495,017, the disclosure of which is incorporated herein by reference. Preferable reinforcement (fibers) for such thermoplastic composites include aramids, glass materials, nickel carbide, silicone carbide, ceramic, carbons and ultra-high molecular weight polyethylene, or a combination thereof. See, for example, U.S. Pat. Nos. 4,968,545, 5,102,723, 5,499,661, 5,579,609, and 5,725,920, the disclosures of which are incorporated herein by reference. Carbon, glass, metals and especially isotropic metals like aluminum, magnesium and titanium, metal-coated organic fibers, and aramid fibers, or a combination thereof, can also be employed as the fibers. See, for example, U.S. Pat. Nos. 5,601,892 and 5,624,115, the disclosures of which are incorporated herein by reference. Preferably, carbon fibers, glass fibers, or aramid fibers, and more preferably Kevlar 29 or 49 fibers are employed in the invention.

The fiber volume in the thermoplastic prepregs may be varied so as to maximize the mechanical, electrical, and thermal properties of the composite member. See, for example, U.S. Pat. No. 5,848,767, the disclosure of which is incorporated herein by reference. High fiber volume parts are stiffer and, in the case of thermally conductive fibers, the parts are more thermally conductive. The fibers of the prepregs may be oriented within the prepreg material in any desired direction as known in the art, such as about 0 to about 90 degrees, including equal numbers of fibers balanced in opposing directions. See, for example, U.S. Pat. No. 4,946,721, the disclosure of which is incorporated herein by reference.

In one aspect of the invention, the composite structural members contain at least one layer of such ORMM materials. One layer is sufficient to form the member and provide the desired structural characteristics for the structural member. Additional layers can be added to improve the strength, stiffness, or other physical characteristics of the structural member. It is possible to use a single layer with fibers having complementary orientations. It is preferred, however, to use a plurality of layers with complementary orientations to balance intrinsic stresses in the layers that make up the sections that result when, as described below, the thermoplastic materials are fully cured. To be complementary, the fibers in successive layers should be symmetric and balanced (e.g., by having the fibers offset from the sheet axis by equal and opposite amounts from one layer to another) as shown in FIG. 2. The fibers can also be oriented to meet the design parameters of the component into which they are being incorporated, e.g., to optimize the structural strength against the expected load. The fibers could be oriented at any suitable angle, including at angles ranging from about 0 to about 90 degrees, including in ±15, ±30, ±45, ±60, and ±75 degrees, or as otherwise known in the art. See, for example, U.S. Pat. Nos. Re. 35,081 and 5,061,583, the disclosures of which are incorporated herein by reference.

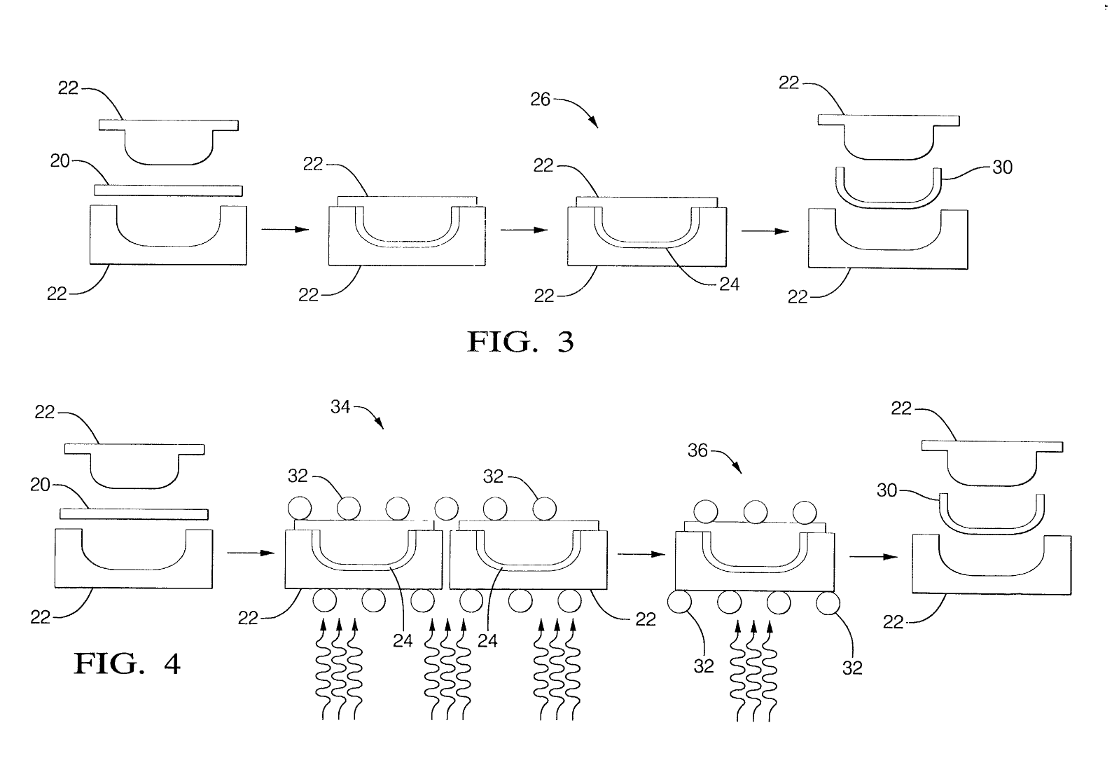

The structural member of the invention can be made by any suitable process known in the art that provides the desired structure. In one aspect of the invention, the composite members are made by the process exemplified in FIG. 3, referred to as the consolidated cold press process. In this aspect of the invention, a composite preform 20 is first created. The composite preform, which is a precursor structure, has substantially the same amount of composite material as desired for the final structural member, but the shape of the precursor structure will be modified by the process to take a different shape.

In one aspect of the invention, the composite preform is made by stacking a plurality of composite plies as described above. During the stacking process, the plies are generally cut and/or patterned to the desired size before being stacked. After being stacked, they are ultrasonically tack-welded together at locations dictated by the design. This allows them to be moved or handled without disturbing the preform.

If desired, a bonding agent can be placed between successive layers of the composite plies. The bonding agent can be placed on selected areas only, or in a pattern such as in rows and/or columns, or over entire sections of the plies. Any suitable agent which helps bond the plies and is compatible with all of the processes employed to make the structural member can be employed, including glues, curing agents, adhesive materials, or a combination thereof. See, for example, U.S. Pat. No. 5,635,306, the disclosure of which is incorporated herein by reference. The bonding agent can be applied by hand or mechanical apparatus prior to or during the stacking process.

Next, the composite perform 20 (with a precursor structure) is loaded into a suitable containing means. Any means that surround and enclose the composite preform can be employed in the invention. In one aspect of the invention, the containing means is a molding apparatus. Any molding apparatus known in the art that can withstand the operating pressures and temperatures (while applying a suitable compressive pressure) can be used in this aspect of the invention. In one aspect of the invention, a matched metal mold made of steel is used in the invention. The mold comes in two or more pieces that fit together to contain the composite preform. The inner surface of the mold has the desired shape that will be imparted to the outer surface of the composite material during the process.

After being loaded in the mold, the mold is then heated at a sufficient temperature, sufficient pressure, and a sufficient time until the various components of the preform (such as the composite plies) become a single consolidated—but molten—member, thus forming an intermediate structure 24. The heating in this stage can be from any suitable heating means, such as using a heated oven 26 and/or using an ultraviolet (U.V.), infrared light (IR), electron beam (E-beam), or microwaves.

The time, temperature, and pressure needed during this stage can be varied to obtain this desired result. The time for this stage depends on the number of molds in the oven and the cooling time required (as described below). In one aspect of the invention, the time during this stage can range from about 5 seconds to about 10 minutes, and is preferably under 1 minute. The pressure is a low pressure of about 0.07 MPa to about 0.7 MPa. The temperature is dependent on the resin matrix material and can generally range from about 150 to about 375 degrees Celsius.

Next, the mold 22 with the intermediate structure 24 is then quickly transferred to a cold press 28. In the cold press, the mold is cooled at a sufficient rate, sufficient pressure, and sufficient time until the various components of the intermediate structure (such as the composite plies) become a solid consolidated member, thereby forming the final structure 30. The cooling in this stage can be accomplished using any suitable cooling means, such as using a cooling fluid like air, water, oil, or through conduction with a cold body.

The time, cooling rate, and pressure during this cooling stage can be varied to obtain this desired result. The time for this stage depends on the number of molds in cooling press and the cooling rate. In one aspect of the invention, the time during this stage can range from about 5 seconds to about 10 minutes, and is preferably about 10 seconds. The pressure is dependent on specific material requirements, but generally is a higher pressure ranging from about 0.7 MPa to about 4.1 MPa, and is preferably about 1.4 Mpa,. The cooling rate can range from about 0.1 to about 30 degrees Celsius/second, and is preferably about 15 degrees Celsius/second. During this stage, the compressive force applied by the mold squeezes the thermoplastic resin in the composite material.

Finally, when the desired temperature is reached, the pressure is released. The mold is opened and the formed composite structural member (the final structure) 30 is removed. Through the processes described above, the plies are physically attached and/or or connected to the adjacent plie(s). Preferably, plies physically bond to the adjacent plie(s), thus forming a substantial permanent physical bond.

The consolidated cold press process eliminates the need for one of the fixed (or static) presses used in the thermoplastic stamping process. In such processes (as described above), two fixed presses are used, e.g., one press for the heating stage and one press for the cooling stage. The consolidated cold press process uses only a single hydraulic press for the cooling stage, thereby reducing the number of presses needed.

The cycle time, or the time between which the system or process yields successive composite structures, in the consolidated cold press process is also greatly reduced. For example, in the thermoplastic stamping processes described above, the cycle time can range from about 3 to about 15 minutes. The cycle time for the consolidated cold press process—which depends on the number of molds in the oven, the cooling time, and the degree of consolidation in the composite preform—is much less. For example, cycle times of about 1 to about 30 seconds may be obtained using the consolidated cold press process.

In another aspect of the invention, the composite structural members of the invention are made by the process exemplified in FIG. 4, referred to as the continuous roll pressing process. In this aspect of the invention, a composite preform 20 with the precursor structure is created as described above. The composite preform is then loaded into a suitable containing means. Any means that surround and enclose the composite preform can be employed in the invention. In one aspect of the invention, the containing means is a molding apparatus. Any molding apparatus known in the art that can withstand the operating pressures and temperatures (while applying a suitable compressive pressure) can be used in this aspect of the invention. In one aspect of the invention, a matched metal mold made of steel is used in the invention. The mold comes in two or more pieces that fit together to contain the composite preform. The inner surface of the mold has the desired shape that will be imparted to the outer surface of the composite preform during the process.

After being loaded in the mold, the mold is then heated at a sufficient temperature and sufficient pressure for a sufficient time until the various components of the preform (such as the composite plies) become a single consolidated—but molten—member, thereby becoming an intermediate structure. The heating in this stage can be from any suitable heating means, such as using a heated chamber 34 and/or using an ultraviolet (U.V.), infrared light (I.R.), electron beam (E-beam), or microwaves.

In a preferable aspect of the invention, the mold is heated between means for transporting the mold. The transport means operates to move or transport the mold along the length of the heating means while applying pressure to the mold. Any transport means known in the art that operates in such a manner can be used in the invention, such as a drive belt, slide, or rollers 32. Preferably, rollers are used in the invention as the transport means due to their simplicity and ability to apply downward pressure. The rollers may apply the necessary pressure to the mold as the mold moves forward along the rollers within the chamber of the heating means. The number and size of rollers can be optimized to provide the necessary heat, pressure, and residence time, as well as allowing energy exchange between them. The number of rollers can range from about 10 to about 100 and the size of the rollers can range from about 1 to about 5 inches in diameter. The rollers can be made from any suitable material that applies the operating pressure at the operating temperature without degrading, such as titanium steel, or aluminum. The rollers must likewise provide sufficient contact surface to the mold so as not to cause plastic deformation in either the rollers or the mold.

The time, temperature, and pressure needed during this stage can be varied to obtain the desired result using the rollers. The time for this stage depends on the number of molds in the oven, the length of the molds, the length of the heating means (i.e., the chamber 34), and the rate at which the molds are inserted into the heating means. In one aspect of the invention, the time during this stage can range from about 10 seconds to about 15 minutes, and is preferably about 30 seconds. The pressure is a low pressure of about 0.07 MPa to about 0.7 MPa, and is preferably about 1.4 MPa. The temperature if dependent on the resin matrix material and can generally range from about 150 to about 375 degrees Celsius

Next, after reaching the required processing temperature, the mold with the intermediate structure 24 is then quickly transferred and cooled. The cooling in this stage can be from any suitable cooling means, such as using a cooled chamber 36. In the cooling means, the mold is cooled at a sufficient rate and at a sufficient pressure and sufficient time until the various components of the intermediate structure (i.e., the composite plies) become a consolidated member. The cooling in this stage can be accomplished using any known cooling mechanism such as a cooling fluid like air, water, oil, or through conduction with a cold body.

In a preferable aspect of the invention, the mold is cooled between means for transporting the mold. The transport means operates to move or transport the mold along the length of the cooling means while applying pressure to the mold. Any transport means known in the art that operates in such a manner can be used in the invention, such as a drive belt, slide, or rollers 32. Preferably, rollers are used in the invention as the transport means due to their simplicity and ability to apply downward pressure. The rollers apply the necessary pressure to the mold as the mold moves forward along the rollers within the chamber of the cooling means. The number and size of rollers can be optimized to provide the necessary pressure, and residence time, as well as allowing energy exchange between them. The number of rollers can range from about 10 to about 150 and the size of the rollers can range from about 1 to about 5 inches in diameter. The rollers can be made from any suitable material that applies the operating pressure without degrading, such as steel, titanium, or aluminum. The rollers must likewise provide sufficient contact surface to the mold so as not to cause plastic deformation in either the rollers or the mold.

The time, cooling rate, and pressure during this stage can be varied to obtain the desired result. The time for this stage depends on the number of molds in the cooling means, the length of the molds, the length of the heating means (i.e., the chamber), and the rate at which the molds are inserted into the cooling means. In one aspect of the invention, the time during this stage can range from about 1 second to about 30 minutes, and is preferably about 10 seconds. The pressure is dependent on specific material requirements and generally is a high pressure of about 0.7 MPa to about 4.1 MPa, and is preferably about 1.4 MPa,. The cooling rate can range from about 1 to about 30 degrees Celsius/second, and is preferably about 15 degrees Celsius/second. During this stage, the compressive force applied by the mold squeezes out excess thermoplastic resin in the composite material.

Finally, when the desired temperature is reached, the pressure is released and the mold exits from the rollers. The mold is opened and the formed composite structural member (the final structure) 30 is removed. Through the processes described above, the plies are physically attached and/or or connected to the adjacent plie(s). Preferably, plies physically bond to the adjacent plie(s), thus forming a substantial permanent physical bond.

Besides those advantages mentioned above, the continuous roll pressing process provides a semi-continuous process. The thermoplastic stamping processes described above all operate as a batch process. The continuous roll pressing process, however, operates as a semi-continuous or continuous process. Thus, the continuous roll pressing process operates more efficiently and quickly.

The continuous roll pressing process also eliminates the need for any fixed (or static) presses. In the thermoplastic stamping processes described above, two fixed presses are used, e.g., one press for the heating stage and one press for the cooling stage. Three molds could be employed to optimize the system with a hot, cold, and load/unload station. The continuous roll press process may use ten to twenty molds to optimize the process and provide a continuous supply of parts. These molds may be all one type of part or can be many different parts for more variety and lower production quantities. By using a moving mold instead of a static mold, a formed structural member can exit from the continuous roll press every 5 or 10 seconds. Using a static mold, a formed structural member exits the process anywhere from 1 to 15 minutes with the two presses depending on the specific parameters of the molding process.

The cycle time in the continuous roll press process is also greatly reduced. For example, in the thermoplastic stamping processes described above, the cycle time can range form about 3 to about 15 minutes. The cycle time for the continuous roll press process—which depends on the length of the roll press, the ability to keep the roll press full of molds, the degree of consolidation in the composite preform, and the length of each mold—is much less. For example, cycle times of about 1 to about 30 seconds may be obtained using the continuous roll press process.

Both of the processes described above produce a high-quality formed composite structural member. In the thermoplastic stamping processes described above, the composite preforms are subjected to high temperatures and high pressures for long periods of time, e.g., 1 to 15 minutes (the “dwell” time). For such long dwell times, the fiber tows in the composite plies spread to a significant degree, e.g., about 130 to about 200% relative to their original configuration. This tow spreading detracts from the surface finish of the formed composite member and may reduce structural performance.

In the processes of the invention, the dwell time is substantially reduced. Thus, less tow spreading occurs because the composite material is subjected to such conditions for substantially shorter periods of time. For example, the tow spreading observed in the formed composite members using the process of the invention ranges from about 2 to about 5%, and preferably is about 2%.

As well, a better surface finish with less fiber print can be obtained using the processes of the present invention. Although not completely understood, it is believed that the better surface finish and less fiber print are obtained because the resin is not allowed to pool in the surface between the woven fibers, thus leaving a more even fiber volume on the surface.

Once formed by either of the processes of the invention, the structural members of the invention can be modified or cut for any desired use. Numerous shapes and configurations can be made by cutting along any dimension of the structural members. Further modifications—other than just cutting—can be made to the structural members of the invention. For example, channels, holes, patterns, and similar modifications can be made in the structural member for many reasons, such as to attach a structural component, modify the surface properties, or a similar purpose. Any structural component known in the art can be added to the structural member, such as a bracket, fastener, coupler, cap, or the like.

The structural member of the invention has numerous uses such as a tie, torsion-bar, tube, beam, column, cylinder and the like and can be used in numerous industries. The structural member of the present invention can be used in the automotive, transportation, aerospace, and defense industries in applications such as airplane components, vehicle components such as tracks, trains, shipping containers, defense-related applications, recreational applications such as bikes, sail masts, shafts for golf clubs and racquets, or commercial applications such as bridges and buildings.

Having described the preferred embodiments of the present invention, it is understood that the invention defined by the appended claims is not to be limited by particular details set forth in the above description, as many apparent variations thereof are possible without departing from the spirit or scope thereof.

We claim:

1. A process for making a composite structural member, comprising:
providing a composite preform in a mold, the preform having a plurality of plies;
heating the mold under light pressure; and
cooling the mold under high pressure to consolidate the plies and make a structural member.

2. The process of claim 1, wherein the composite preform comprises a reinforcement material in a polymer matrix.

3. The process of claim 2, wherein the polymer matrix comprises a thermoplastic polymer.

4. The process of claim 1, further including heating the mold at a temperature of about 150 to about 375 degrees Celsuis.

5. The process of claim 1, wherein the light pressure ranges from about 0.07 to about 1.4 MPa.

6. The process of claim 1, further including cooling the mold at a rate of about 1 to about 15 degrees Celsius/second.

7. The process of claim 1, wherein the high pressure ranges from about 1.4 to about 4.1 Mpa.

8. The process of claim 1, the process having a cycle time ranging from about 1 to about 30 seconds.

9. A process for making a composite structural member, comprising:
providing a composite preform in a mold, the preform having a plurality of plies;
heating the mold under light pressure;
cooling the mold under high pressure to consolidate the plies and make a structural member;
wherein the cycle time of the process ranges from about 1 second to about 30 seconds.

10. A process for making a composite structural member, comprising:
providing a composite preform in a mold, the preform having a plurality of plies comprising a reinforcement material in a polymer matrix;
heating the mold under a pressure ranging from about 0.07 to about 0.7 MPa;
cooling the mold under pressure ranging from about 1.4 to about 4.1 Mpa to consolidate the plies and make a structural member;
wherein the cycle time of the process ranges from about 1 second to about 30 seconds.

11. A composite structural member made by the method comprising:
providing a composite preform in a mold, the preform having a plurality of plies;
heating the mold under light pressure; and
cooling the mold under high pressure to consolidate the plies and make a structural member.

12. A composite structural member made by the method comprising:
providing a composite preform in a mold, the preform having a plurality of plies;
heating the mold under light pressure; and
cooling the mold under high pressure to consolidate the plies and make a structural member;
wherein the cycle time of the process ranges from about 1 second to about 30 seconds.

13. A composite structural member made by the method comprising:
providing a composite preform in a mold, the preform having a plurality of plies comprising a reinforcement material in a polymer matrix;
heating the mold under a pressure ranging from about 0.07 to about 0.7 MPa; and
cooling the mold under pressure ranging from about 1.4 to about 4.1 Mpa to consolidate the plies and make a structural member;
wherein the cycle time of the process ranges from about 1 second to about 30 seconds.

14. An apparatus for making a composite structural member, comprising:
containing means for containing a composite perform;
means for heating the containing means; and
means for cooling the containing means;
wherein the containing means is transferred between the heating means and the cooling means on a continuous basis.

15. The apparatus of claim 14, wherein the containing means comprises a mold.

16. The apparatus of claim 15, wherein the mold is a matched metal mold.

17. The apparatus of claim 14, wherein heating means comprises rollers.

18. The apparatus of claim 17, wherein the rollers enclose the containing means and apply pressure thereto.

19. The apparatus of claim 14, wherein the cooling means comprises rollers.

20. The apparatus of claim 14, wherein the rollers enclose the containing means and apply pressure thereto.

21. An apparatus for making a composite structural member, comprising:
containing means for containing a composite perform;
means for heating the containing means, the heating means comprising rollers; and
means for cooling the containing means, the cooling means comprising rollers;
wherein the containing means is transferred between the heating means and the cooling means on a continuous basis.

22. An apparatus for making a composite structural member, comprising:
containing means for containing a composite perform;
means for heating the containing means, the heating means comprising rollers enclosing the containing means and applying pressure thereto; and
means for cooling the containing means, the cooling means comprising rollers enclosing the containing means and applying pressure thereto;
wherein the containing means is transferred between the heating means and the cooling means on a continuous basis.

23. A system containing an apparatus for making a composite structural member, the apparatus comprising:
containing means for containing a composite perform;
means for heating the containing means; and
means for cooling the containing means;
wherein the containing means is transferred between the heating means and the cooling means on a continuous basis.

24. A system containing an apparatus for making a composite structural member, the apparatus comprising:
containing means for containing a composite perform;
means for heating the containing means, the heating means comprising rollers enclosing the containing means and applying pressure thereto; and
means for cooling the containing means, the cooling means comprising rollers enclosing the containing means and applying pressure thereto;
wherein the containing means is transferred between the heating means and the cooling means on a continuous basis.

25. A system containing an apparatus for making a composite structural member, the apparatus comprising:
containing means for containing a composite perform;
means for heating the containing means, the heating means comprising rollers enclosing the containing means and applying pressure thereto; and
means for cooling the containing means, the cooling means comprising rollers enclosing the containing means and applying pressure thereto;
wherein the containing means is transferred between the heating means and the cooling means on a continuous basis.

26. An intermediate composite structure comprising a plurality of composite plies, the plies having a molten thermoplastic polymer matrix substantially infiltrated within the individual tows and between the plies.

27. A composite structural member comprising a plurality of composite plies, the plies containing substantially consolidated fiber tows without significant fiber spreading.
